(19) United States
(12) Patent Application Publication
(10) Pub. No.: US 2008/0133394 A1
(43) Pub. Date: Jun. 5, 2008

(54) Method for setting prices and accepting bid amounts in time deterministic sales transactions

(76) Inventor: Forrest Franks, Burnsville, MN (US)

Correspondence Address: Gary L. Huusko;Suite 600, 7300 West 147th Street, Apple Valley, MN, 55124, US

(21) Appl. No.: 11/607,730

(22) Filed: Dec. 1, 2006

(51) Int. Cl. G06Q 30/00

(52) U.S. Cl. 705/37

(57) ABSTRACT

The invention is an auction method for setting prices and accepting bid amounts in time deterministic sales transactions such that a number of bidding slots are available each day of the auction term, each bidding slot with a reserve bid amount, allowing a bidder to make a bid at one of the reserve bid amounts, at which time all bid slots after the time of the bid slot containing the bid become unavailable, and as time passes, each bid slot containing a reserve bid amount that is earlier than then current time also becomes unavailable. The reserve bid amounts that remain available are increased, thus requiring subsequent bidders to make a bid early in order to secure a certain reserve bid price, or forgo the opportunity to purchase the auction item, or pay a higher amount for the auction item as each day passes. This encourages bidders to bid early, thus securing a lower possible purchase price. As all bid slots after the date in which a bid has been made in an amount of a reserve bid amount are unavailable, this sets an end date of the auction. The auction also ends when a bidder makes a present bid equal to the then current reserve bid amount.

### BACKGROUND OF THE INVENTION

1. Field of Invention

This invention generally relates to setting prices of goods and services (the merchandise) and a predetermined timeline duration of sale, specifically setting the merchandise's price relative to the price's assigned time slot within the total timeline of the sale.

2. Prior Art

Previously, prices in places of commerce were statically set with no deterministic, buyer induced, price adjustments. This puts the buyer at a disadvantage if the product is priced too high, and the seller at a disadvantage if the product is priced too low. Auctions allow a more dynamic price negotiation method, but can have similar extreme price disadvantages. Modern, on-line, auctions have a fixed end time. This allows a minimally higher, last moment bid to outbid the current high bid, which causes a lost auction with no method for the auction loser to re-bid on the auction. Modern auctions also have the disadvantage of forcing the high bidders to wait until the full, preset duration of the auction lapses before being declared the auction winner.

There are several different ways in which an auction can be conducted, all of which are well know in the art. Conventional auction techniques include the English auction, also known as the first-price, open-bid auction, in which the highest price bid is the price paid and every bidder knows the bids made by others. Another auction mechanism is the Dutch auction, in which a seller offers lower and lower prices until a buyer or set of buyers claims the item at the last offered price. In a double auction, sellers offer lower and lower prices while buyers offer higher and higher prices until they meet. In a first-price sealed-bid auction, fixed bids are submitted and the highest is accepted. In a second-price sealed-bid auction, the highest bid is accepted, but the highest bidder pays the amount bid by the second-highest bidder.

U.S. Pat. No. 5,890,138 by Godin, et al., details an implementation of a standard auction within an on-line setting. The embodiment of this prior patent's design is an auction with a fixed ending time and starting amount, where the starting amount decreases with time. This design is still encumbered by traditional auction limitations that lack fixed price determinism, and lack the advantage of negotiating the auction, or sale's, completion time.

U.S. Pat. No. 6,519,570 by Faber, et al., is a queue based auction that has time related bidding, but is designed around having bidders compete directly against each other for preferential treatment by moving them up a queue. This prior method creates an environment where minimal, last-moment, over-bids supersedes the initial bid risk versus the time spent waiting for the auction bid amount to become the serviced bid.

U.S. Pat. No. 6,499,018 by Alaia, et al., is directed at allowing auction closing times to be elongated dynamically to maximize bidding and profit for the seller. This prior method has the consequence of not rewarding early bidders, lowers sale volume by elongating sale times, and indeterminately increases delivery time to bidders as they do not have an upper boundary on the sale closing.

While the prior art has provided many well proven systems for allocating a resource through various auction and arbitration systems, those systems are not suitable for expediting the purchase process while providing a deterministic, mutual buyer and seller beneficial, time versus price, negotiation environment.

Accordingly, several objects and advantages of the present inventive method are that it provides a method to allow a deterministic price negotiation between buyers and sellers, with the benefits of an auction, and with the buyer satisfaction of a fixed price, “shop-around”, sale. The method also prevents a minimal, last moment, outbid from stealing an auction while providing a deterministic method to shorten the duration of the auction for the time and monetary benefit of both the buyer and seller. Because of the inherent determinism with this method, it provides a sound, enjoyable environment for buyers to actually influence the price they pay for products without the unnecessary concerns that other methods induce. The present invention also allows a flexible auction exposure time, prior to the first bid, to help alleviate a premature end to an unbid auction that would have performed better if it had more time to be located by potential buyers.

Further objects and advantages will become apparent from a consideration of the ensuing description and drawings.

### BRIEF DESCRIPTION OF DRAWINGS

FIG. 1 is comprised of four sub-figures identified and denoted by Day 1, Day 1—Post 1^{st} bid, Day 2 and Day 3 of a seven day auction. They illustrate an example of the method within the context of an auction by displaying the current available prices which are available for bidding at certain determined times. FIG. 1 shows an example auction that lasts for seven days, although various time periods can be used for the auction, such as hours, minutes or even seconds, or increments of each. Longer time periods could be used as well, such as weeks or months. Likewise, each auction time period could be divided into one or more bid slots, each bid slot being some point in time within the auction time period, thus, if the auction was for an hour, the auction time period could be FIG. 2 illustrates a sliding auction or purchase window that can be used to maintain a set auction length prior to initial bidding or while non-purchased supplies last.

### DETAILED DESCRIPTION OF PREFERRED EMBODIMENT

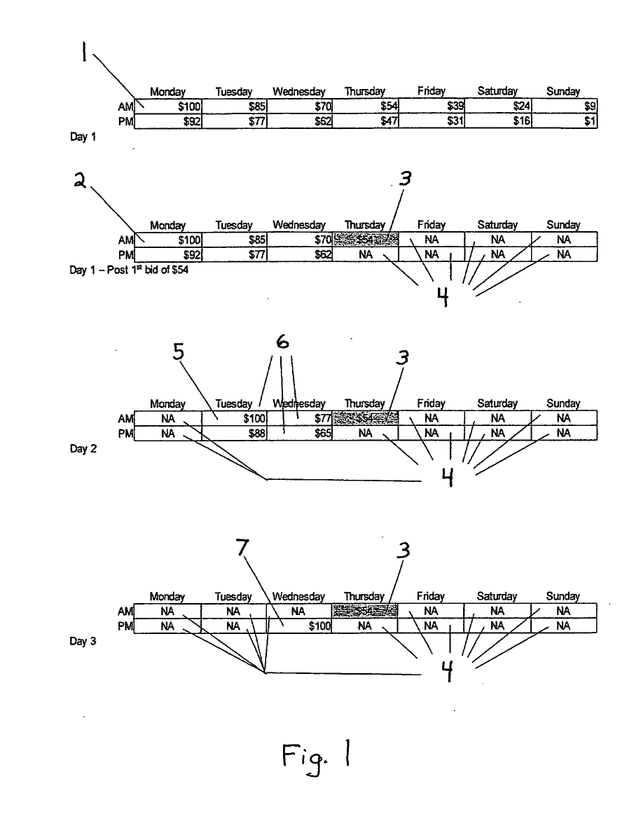

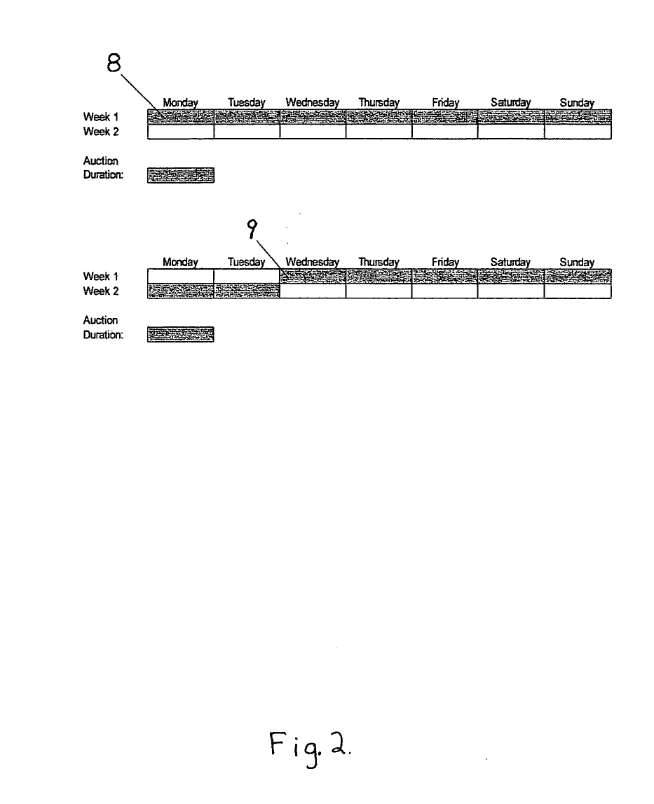

FIG. 1 is an illustration of a single seven day auction that shows the progression of auction events which, in the example, include current time and a bid.

Referring first to FIG. 1, a day one present time bid slot 1 is shown. Day 1 shows the initial auction setup. The example auction is composed of seven days, although any predefined auction duration can be used, where the present time is denoted by the present time bid slot 1, with each auction duration further comprises duration units, such as days, and each duration unit is divided into at least two bid slots, shown here as an AM bid slot and a PM bid slot to coincide with the AM hours and PM hours of the day. The two bid slots per day also denote the individual bid amount versus time slot relationships which are available for possible bids. For purposes of illustration, the auction is preset with a possible bidding range from $1 to $100. Any price bidding range can be used, depending upon the goods or services being sold. The numbers filling out each time slot of the auction denote the reserve bid amount necessary to reserve a purchase price for the item at that particular point in time. Should a reserved, or purchased, slot become the present time slot, the auction is concluded, and the owner of the reserved slot is declared the winner for the negotiated price. Although the example shows two time slots per day with a linear price distribution, the actual number of time slot divisions and their corresponding price amounts can be varied using any formula or arbitrary values.

Likewise, the duration units can be predefined or dynamically defined, and the predefined or dynamically defined duration units can be of equal or variable lengths.

Referring still to FIG. 1, Day 1—Post 1^{st} bid, a present time post first bid 2 is shown where a bidder has posted an initial bid of $54 as noted in a first bid versus time amount location 3. The initial bid of $54 sets a duration of the auction of Thursday morning, as shown by the first bid versus time amount location 3. Day one post first bid unavailable bid positions 4 show that no bids can be accepted after Thursday afternoon, thus setting a minimum sales price of $54.

Referring still to FIG. 1, a Day 2 present time bid slot 5 shows the amount that can be bid on Tuesday morning, that is, if a bidder wishes to purchase the good or service immediately, he or she must still bid the maximum price of $100. Newly scaled bid amounts 6 based on total remaining auction time are shown in Day 2 of FIG. 1. Again, the scaled bid amounts 6 can be based upon any price determination, whether mathematically determined or arbitrarily chosen. If the bidder is willing to wait, he or she may bid an amount indicated between the maximum price of $100 and the minimum price of $54, thereby taking a chance that the item does not sell at the maximum price or at some price between the bidders bid and the maximum price. Day 2 shows the unavailable bid positions 4 extended to the days and times that have already passed.

On Day 3, a present time bid slot 7 is shown, indicating in a compressed bidding time period, resulting from the passage of time and the bid of $54 shown at the first bid versus time amount location 3. Once again, the unavailable bid positions 4 have extended.

Day 1—Post 1^{st} Bid of Day 1 shows the state of the defined bid slots after an initial bid occurs. Day 2 shows the next state of the auction after a period of time (one day) passes. Day 3 shows the state prior to auction end, thus illustrating the prevention of a last moment, minimal bid from stealing the auction.

In operation, Day 1 illustrates the starting setup of the example auction with present time being illustrated by present time bid slot 1. Day 1—Post 1^{st} Bid shows the result when a bid occurs for the value of $54. The present time post first bid 2 shows that the present time is still within the first bid slot. The first bid versus time amount location 3 shows that the $54, Thursday AM, bid slot is now reserved as the current highest bidder's slot. Should the present time reach that slot, that bidder would be declared the winner of the auction. The unavailable bid positions 4 illustrate that when the Thursday AM bid slot was reserved, all of the subsequent bids are now declared unavailable because the auction duration has been shortened to end when the first bid versus time amount location 3 slot is reached. This shows how the time savings benefit occurs when offers are made to allow the seller to be rewarded with a higher bid price, while both the buyer and seller are rewarded with a shorter auction duration.

The Day 2 present time bid slot 5 illustrates that the present time slot location is on Tuesday AM with the first bid versus time amount location 3 showing that the $54 bid is still the highest bid on the Thursday AM time slot. The newly scaled bid amounts 6 shows that since the total auction duration has been shortened, a scaling factor is applied for the remaining bidding slots which, in this example, increases the slope of possible bids which causes the next minimum bid amount to be considerably greater than before. This has the benefit of rewarding an earlier bidder that makes a moderately high bid early on by deterministically creating a higher next minimum bid. The unavailable bid positions 4 illustrate Day 2's unavailable bid slots caused by the progression of time and the first bid. It can also be noted that the increase of the price slope automatically creates a disincentive to perform a last moment bid in hopes of cheaply stealing a sale.

Day 3 accelerates the current time, denoted by the present time bid slot 7, to the Wednesday PM time slot which is the slot adjacent to the first bid versus time amount location 3, which was the initial $54 bid. The unavailable bid positions 4 of Day 3 re-illustrate the unavailable bidding slots that occur because of time progression and the placed bids of the auction. The only bid slot remaining is the present time bid slot 7 which when scaled creates the condition where the only possible valid bid amount is the full highest price of $100. This still allows the auction to change hands by a new high bidder, but since the only allowable bid is also the auction's maximum allowable bid, it was not necessary to wait until the end of the auction to bid that amount, and thus eliminates the malicious practice of stealing auctions with a last moment, minimalistic bid. The auction will also end when the current time reaches the current high bid amount, instead of being forced to wait until a predetermined end of auction time which could be days or weeks with a traditional modern auction or sale method. The early ending allows the buyer to purchase their merchandise earlier, and allows the seller to have a faster turn-around while still maximizing the advantages for both parties.

Referring now to FIG. 2, an illustration of a sliding auction or purchase window that can be used to maintain a set auction length prior to initial bidding or while non-purchased supplies last is shown.

Days 1 through 3 can be re-interpreted for use in a store or sales house to allow deterministic customer negotiation dependent on the customer's willingness to wait for the merchandise with the possibility of supplies running out which, once again, maximizes the price benefits for both parties.

As previously described, the primary advantage of the invented method is to use it in an auction like environment where a plurality of people are competing for one or more products. Because the inventive method bases the pricing structure on a time dependent function, this allows the alternative implementation where a starting auction length can be defined as opposed to an auction stopping time. By using a starting length with this auction method, as long as there are no live bidders, the auction length can remain constant, while the perceived auction end time slides at the appropriate increments of real-time. FIG. 2 illustrates a two week period view with a first week seven day auction 8 (shaded) spanning from Monday to Sunday, of a seven day auction. FIG. 2 also illustrates the resulting shift of the running auction's end-time if current time progresses to Wednesday of the first week without any bids. The shaded seven day auction now becomes a second week shifted seven day auction 9 (shaded) that now spans from the Wednesday of the first week through to Tuesday of the second week.

Another possible embodiment of the invention is within a store or other sales house to use this pricing scheme as a method of deterministic price negotiation with customers. The store could display the current price or prices, but inform the potential buyers that if they would purchase the product, but be willing to actually wait before receiving selected product, they would get the opportunity to pay a cheaper price. The establishment could also integrate a limited supply into the establishment's sales method to provide the more expensive, but earlier purchasers to have a higher chance of actually receiving the merchandise before supplies run out. This would create a true customer adjusted pricing structure that would naturally ensure that stores were always on the optimal point of the supply versus demand curve.

Accordingly the reader will see that, according to the invention, a method is provided for pricing and selling goods that is workable in both an auction and store environment. The invented method allows for a deterministic, bartering element that saves both time and money, for both the buyer and seller, while eliminating the practice of auction stealing which is extremely prevalent in on-line auction houses. Also embodied is a corollary sliding auction, or sales window, method which allows for an auction or sale end-time to deterministically change as time progresses or as bids and purchases are made. As this is an improvement over current auction methods, and has a variety of uses in various other sales or transaction environments, the advantage of the method's deterministic buyer/seller negotiation creates an environment where both parties get measurable benefits that improve the overall well-being of commerce where this is implemented.

While the above description contains much specificity, these should not be construed as limitations on the scope of the invention, but as exemplifications of the presently preferred embodiments thereof. Many other ramifications and variations are possible within the teachings of the invention. For example, the time relationships can be changed in length, or related value, to follow any formula, or be composed of manually decided values. The intended use could embody other scheduling problems where the monetary units could be transposed with other meaningful scarce resources. The starting or ending price also can be dynamic with events of, or independent from, the auction or sale. These, and similar modifications of the method, shall be deemed a natural and obvious extension of the invention's premise. Also, the method makes no distinction for the physical or logical locations of the sales, which may include, but are not limited to, sales sites, auctions, or transaction systems which exist on a network, within a computer, or are in the physical environment, or within another unforeseen medium or containers. The length of the auction could be more or less than seven days, it could be defined in months, weeks, hours or minutes, and each time bid slot 1 would then be a set time within that auction length of time.

Thus the scope of the invention should be determined by the appended claims and their legal equivalents, and not by the examples given.

I claim:

1. An auction method for setting prices and accepting bid amounts in time deterministic sales transactions comprising
at least one auction item,
a predefined auction duration having a plurality of duration units, each duration unit being divided into a plurality of bid slots,
a plurality of auction events,
a current time,
at least one bid,
at least one scaled bid amount,
a bidding range,
a plurality of reserve bid amounts,
a plurality of reserve bid amount slots,
a present time bid slot,
a present time post first bid,
at least one unavailable bid position,
a first bid versus time amount location,
and an individual bid amount,
wherein the predefined auction duration, the plurality of duration units, the plurality of bid slots for each duration unit, the bidding range and the plurality of reserve bid amounts are determined, the plurality of reserve bid amount slots being determined by multiplying the determined number of duration units by the determined number of bid slots in each duration unit, the reserve bid amounts being within the determined bidding range, each determined reserve bid amount being entered into the reserve bid amount slots beginning with the largest reserve bid amount being entered into the earliest reserve bid amount slot which would correspond to the current time, with each successive later dated reserve bid amount slot having a lower reserve bid amount entered until all available reserve bid amount slots contains a reserve bid amount,
wherein the bid is made on the auction item and entered into the bid slot corresponding to the reserve bid slot containing the closest reserve bid amount that is not greater than the bid, that reserve bid slot becoming the first bid versus time amount location, with all later dated bid slots each then becoming unavailable bid positions such that the bid made becomes the lowest price the auction item or auction items will be sold for, thus setting an end time and date of the auction at the time and day of the bid slot in which the bid was entered,
wherein any subsequent bid being made for the auction item or auction items must be in an amount greater than the bid entered in the first bid versus time amount location,
wherein as time progresses, each reserve bid amount slot that is prior to the current time becomes the unavailable bid position, each reserve bid amount in each later reserve bid amount slot being scaled upward to become scaled bid amounts such that further bids must be equal or greater than the scaled bid amount in each reserve bid amount slot, thus requiring set increased bid amounts and preventing nominal bid amount increases over prior bids, the reserve bid amount slot at the current time becoming the present time bid slot which would contain the highest individual bid amount needed to purchase the auction item or auction items,
wherein, the auction will end when the bid made equals the reserve bid amount in the present time bid slot or the present time bid slot contains a bid made, and the auction item or auction items is then purchased for that bid.

2. The auction of claim 1 wherein the plurality of duration units are predefined.

3. The auction of claim 1 wherein the plurality of duration units are dynamically defined.

4. The auction of claim 2 wherein the predefined plurality of duration units are of equal lengths.

5. The auction of claim 3 wherein the dynamically defined plurality of duration units are of equal lengths.

6. The auction of claim 2 wherein the predefined plurality of duration units are of variable lengths.

7. The auction of claim 3 wherein the dynamically defined plurality of duration units are of variable lengths.

8. The auction of claim 1 wherein the plurality of duration units are days and the plurality of bids slots for each duration unit equals two, each such bid slot corresponding to either the a.m. (morning) or p.m. (afternoon) hours.

9. The auction of claim 1 wherein the bidding range is from one hundred dollars to one dollar.

10. The auction of claim 1 wherein the auction takes place in a retail store.

11. The auction of claim 1 wherein the auction takes place online, utilizing Internet and computer means to run the auction and to place bids on the auction item or auction items.

12. The auction of claim 1 wherein the auction items are goods.

13. The auction of claim 1 wherein the auction items are services.
